(19) United States
(12) Patent Application Publication
(10) Pub. No.: US 2024/0001705 A1
(43) Pub. Date: Jan. 4, 2024

(54) MEDICAL TUBING MARKER AND METHOD

(71) Applicant: Paul Connor Shanahan, Knoxville, TN (US)

(72) Inventor: Paul Connor Shanahan, Knoxville, TN (US)

(21) Appl. No.: 17/810,627

(22) Filed: Jul. 4, 2022

(51) Int. Cl. B43K 8/02

(52) U.S. Cl. CPC B43K 8/022

(57) ABSTRACT

A marker having a body, a core having an ink and the core being within the body, and a tip having a first end connected to the core and the tip extending from the body towards a second end. The tip further has a first side opposite a second side and a front side opposite a back side, with the first side and second side therebetween. The second end has a concave section between the first side and the second side and the concave section is configured to accommodate a circumferential arc of intravenous tubing within the concave section to deposit the ink.

### BACKGROUND OF THE INVENTION

### Technical Field

This application relates generally to apparatuses, devices, and methods for marking and tracking tubes and more particularly to apparatuses, devices, and methods for marking and tracking tubes transporting fluid infusions to a patient in a medical environment.

### Background Information

In a medical environment, such as, for example, a hospital an operating room, an emergency room, an ambulance, a doctor's office, or a similar environment, tubes connected to patients for the infusion of fluid are often difficult to tell apart because such tubes are almost always clear, similar in size, full of clear fluid, and travel a significant distance to reach the patient. These tubes often tangle with one another and because of the distances from the fluid source to the patient the tubes require careful tracing back to its source, usually a bag of medication hanging from an intravenous pole, to know what fluid is in the tube. Often tube tracking is done in a high stress environment and mistakes may improperly mix medications or result in incorrect dosages. This may result in fatal consequences.

Current solutions involve tracing tubes as needed or wrapping colored stickers around the tubes or taping marked tags around the tubes. However, in high stress emergency environments quickly applied stickers or adhesive tags may fall off.

Alternatively, pens and markers have also been used. Pens generally have sharp points that may pierce or damage the tubing. Pens also may not be able to write on medical tubing. Felt or other soft tipped markers may also be used, but because intravenous tubing often has a small diameter, marking is difficult in a high stress environment.

There is a need for a way of identifying medical tubes whether in a high stress environment or otherwise that can easily mark the tubes without damaging them and make fluid tracking easier.

### SUMMARY OF THE INVENTION

The present disclosure is directed toward systems, methods, and devices, for marking and keeping track of fluid carrying medical tubing.

In one aspect of the present disclosure provided herein, is a marker having a body, a core having an ink and the core being within the body, and a tip having a first end connected to the core and the tip extending from the body towards a second end. The tip further has a first side opposite a second side and a front side opposite a back side, with the first side and second side therebetween. The second end has a concave section between the first side and the second side and the concave section is configured to accommodate a circumferential arc of intravenous tubing within the concave section to deposit the ink.

In another aspect of the present disclosure provided herein, is a method for tracking fluids in intravenous tubing including: connecting an intravenous tube at a first end to a fluid source and at a second end to a patient connection; selecting a marker having indelible ink of a color, the marker having a concave section at an end of a tip, the concave section sized and dimensioned to accommodate a circumferential arc of an intravenous tube; placing the concave section in contact with the circumferential arc of the intravenous tube near the first end of the intravenous tube; marking near the first end of the intravenous tube with the concave marker and applying indelible ink of the color on the circumferential arc of the intravenous tube; placing the concave section in contact with the circumferential arc of the intravenous tube near the second end of the intravenous tube; marking near the second end of the intravenous tube with the marker such that indelible ink of the color remains on the circumferential arc of the intravenous tube; and recording and associating the color with a first intravenous fluid.

In another aspect of the present disclosure provided herein, is a method for tracking fluids in intravenous tubing including: a) selecting a plurality of intravenous tubes each connected at a first end to at least one fluid source and at a second end to a patient connection; b) selecting a plurality of markers, each of the plurality of markers having indelible ink of a different color, and each of the plurality of markers having a concave section at an end of a tip, the concave section sized and dimensioned to accommodate a circumferential arc of each of the plurality of intravenous tubes; c) selecting a marker of the plurality of markers and selecting an intravenous tube of the plurality of intravenous tubes and placing the concave tip in contact with the circumferential arc of the intravenous tube at the first end of the intravenous tube; d) marking near the first end of the intravenous tube with the concave tip and applying indelible ink of a color on the circumferential arc of the intravenous tube; e) placing the concave tip in contact with the circumferential arc of the intravenous tube near the second end of the intravenous tube; f) marking the second end of the intravenous tube with the concave tip such that indelible ink of the color remains on the circumferential arc of the intravenous tube and the marking near the first end and the marking near the second end are of the same color; g) recording and associating the color with the source of the intravenous fluid; and h) repeating steps c)-g) for each of the plurality of intravenous tubes until each of the plurality of intravenous tubes is marked with a different color.

These and other objects, features, and advantages of this disclosure will become apparent from the following detailed description of the various aspects of the disclosure taken in conjunction with the accompanying drawings.

### BRIEF DESCRIPTION OF THE DRAWINGS

The present invention will be understood more fully from the detailed description given hereinafter and from the accompanying drawings of the preferred embodiment of the present invention, which, however, should not be taken to limit the invention, but are for explanation and understanding only.

FIG. 1A depicts a perspective view of a marker with a tip to accommodate tubing, in accordance with an aspect of the present invention;

FIG. 1B depicts a close-up perspective view of the tip of the marker of FIG. 1, in accordance with an aspect of the present invention;

FIG. 2A depicts the marker of claim 1 with the marker tip in contact with a cross-section of intravenous tubing, in accordance with an aspect of the present invention;

FIG. 2B depicts a cross section view of the marker of claim 1 with the marker tip in contact with the cross section of the intravenous tubing, in accordance with an aspect of the present invention;

FIG. 2C depicts a cross section view of the marker of claim 1 with another embodiment of the marker tip in contact with the cross section of the intravenous tubing, in accordance with an aspect of the present invention;

FIG. 3 depicts a primary and secondary intravenous tubing setup, in accordance with an aspect of the present invention;

FIG. 4 depicts intravenous tubing with markings, including markings at a lumen side port, in accordance with an aspect of the present invention;

FIG. 5 depicts a drip chamber of the intravenous tubing of FIG. 4 with two markings, in accordance with an aspect of the present invention;

FIG. 6A depicts a perspective view of a marker with multiple colored tips to accommodate tubing, in accordance with an aspect of the present invention;

FIG. 6B depicts a close-up perspective view of a tip of the marker of FIG. 6A, in accordance with an aspect of the present invention.

FIG. 7 is a block diagram depicting a method for tracking fluid entering a patient through intravenous tubing in accordance with an aspect of the present invention;

FIG. 8 is a process flow diagram depicting a method for tracking fluid entering a patient through intravenous tubing in accordance with an aspect of the present invention.

### DETAILED DESCRIPTION OF THE EMBODIMENTS

The present invention will be discussed hereinafter in detail in terms of various exemplary embodiments according to the present invention with reference to the accompanying drawings. In the following detailed description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

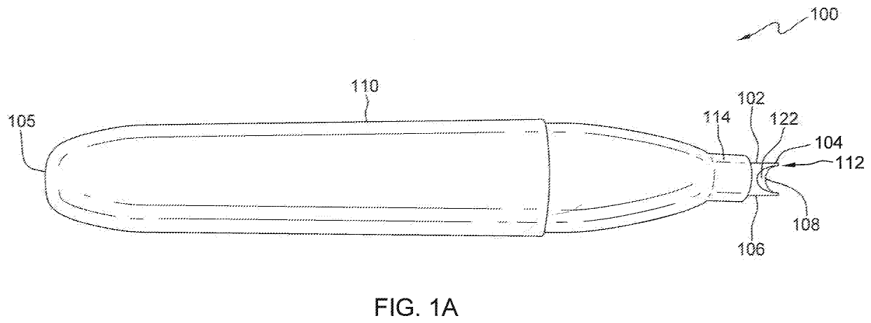

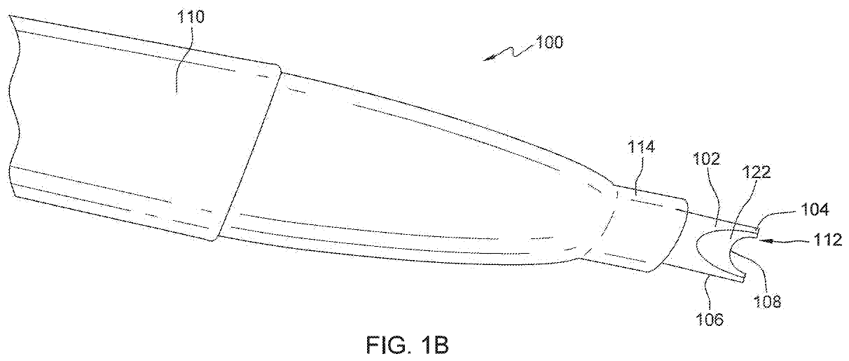

Thus, all the implementations described below are exemplary implementations provided to enable persons skilled in the art to make or use the embodiments of the disclosure and are not intended to limit the scope of the disclosure, which is defined by the claims. As used herein, the word “exemplary” or “illustrative” means “serving as an example, instance, or illustration.” Any implementation described herein as “exemplary” or “illustrative” is not necessarily to be construed as preferred or advantageous over other implementations. Moreover, in the present description, the terms “upper”, “lower”, “left”, “rear”, “right”, “front”, “vertical”, “horizontal”, and derivatives thereof shall relate to the invention as oriented in FIG. 1.

The following description references systems, methods, and apparatuses for marking and organizing intravenous tubing, with such tubing delivering medical fluids and medication to a patient. However, those possessing an ordinary level of skill in the relevant art will appreciate that other medical objects and devices are suitable for use with the foregoing systems, methods, and apparatuses. Likewise, the various figures, steps, procedures and work-flows are presented only as an example and in no way limit the systems, methods or apparatuses described to performing their respective tasks or outcomes in different time-frames or orders. Unless otherwise expressly stated, it is in no way intended that any method set forth herein be construed as requiring that its steps be performed in a specific order. The teachings of the present invention may be applied to any medical tubing object.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The various embodiments described herein provide for apparatuses, devices, and methods for marking and organizing intravenous tubing, with such tubing delivering medical fluids and medication to a patient. Particularly, for marking and organizing intravenous tubing in an emergency or surgical environment where multiple intravenous tubes may be used to deliver fluids to a patient and with such intravenous tubes having one or more ports for connections with other fluid containers, other intravenous tubes.

Referring to FIG. 1, a marker 100 is depicted having a body 110 and a tip 102. The tip 102 may also be referred to as a nib. The tip 102 has a free end 112 extending from the body 110. The free end 112 is between a first side 104 opposite a second side 106. The free end 112 has a concave section 108 between the first side 104 and the second side 106, with the concave section extending into the body 110 in a semi-circular section. The body 110 is depicted as a tube having a circular circumference and having a tapered or conical section 114 at one end, out of which the tip 102 extends from. The body further has a bottom end 105, opposite the tip 102. In other embodiments, the body 110 of marker 100 may be, for example, any shape and is not limited to a circular tube. Tip 102 is also shown tapering towards the free end 112, with a front side 122 opposite a back side (not shown), with the front side 122 tapering towards a back side (not shown) longitudinally towards the free end 112.

In some embodiments, the tip 102 may be configured (e.g., shaped and dimensioned), for example, so that the first side 104 and the second side 106 extend approximately the same distance from the body 110. In other embodiments, the tip 112 may be configured (e.g., shaped and dimensioned) so that the first side 104 may, for example, extend further from the body 110 than the second side 106 (or the second side 106 extending further from the body 110 than the first side 104). In still other embodiments, the first side 104 and the second side 106, may taper towards each other and the front side 122 and the back side may also taper towards each other.

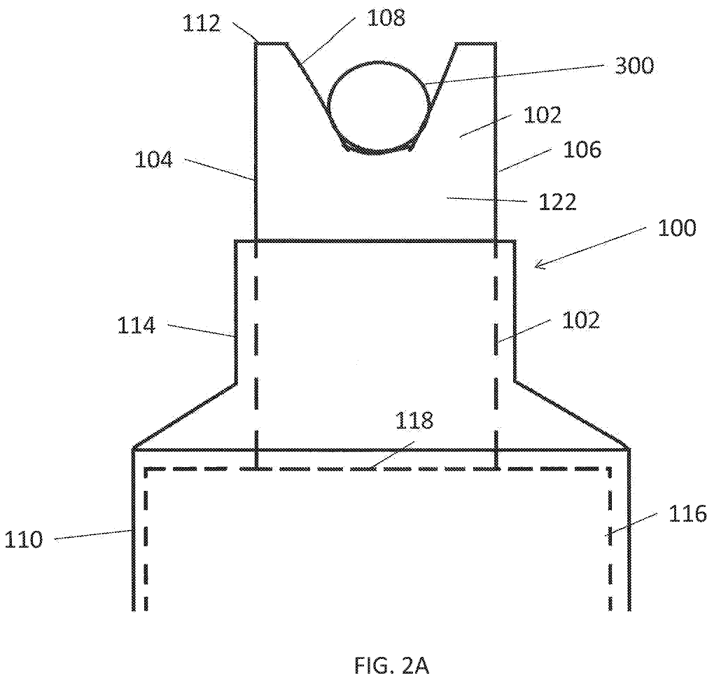

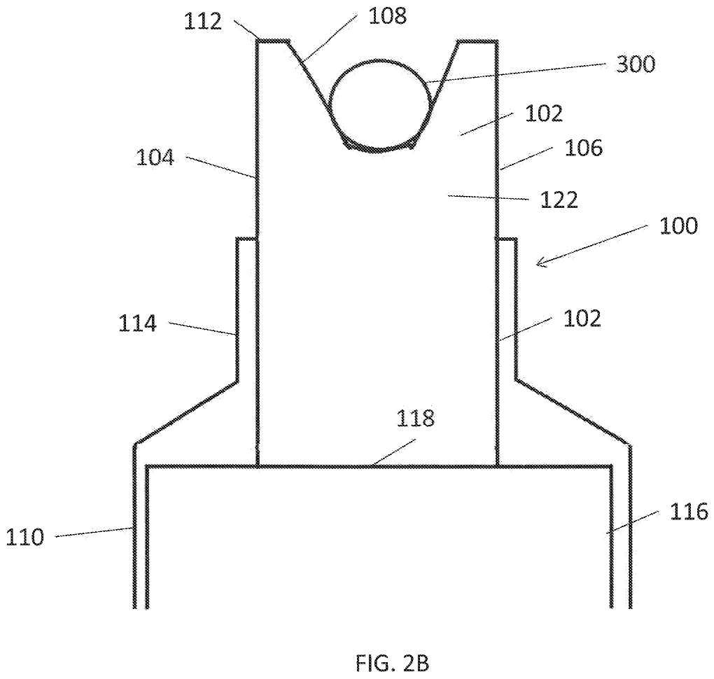

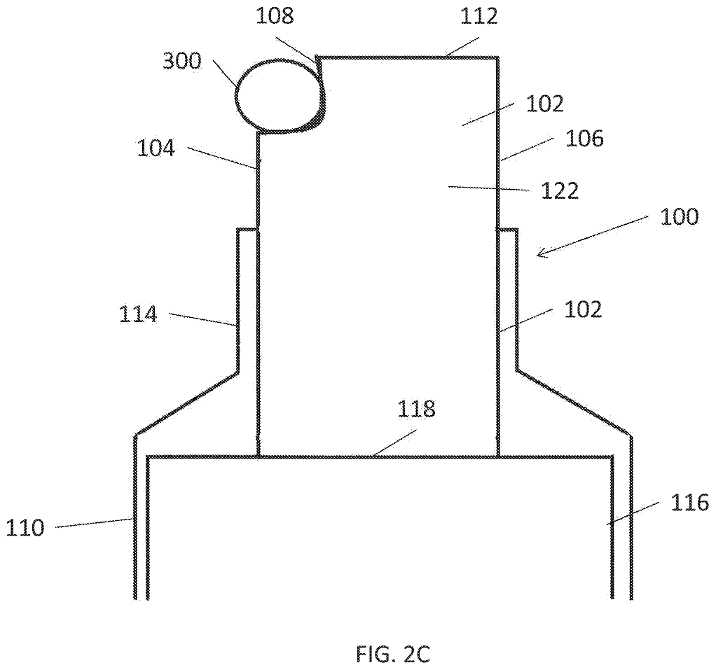

Referring to FIGS. 2A and 2B, a close-up of the marker 100 is depicted having a body 110. The body has a narrower section 114, out of which tip 102 emerges. The narrower section is depicted in FIG. 1 as a conical shape but it can be, for example, any shape. In some embodiments, the narrower section 114 may be, for example, just a continuation of the body 110, with no actual narrowing. In certain other embodiments, marker 100 may have, for example, a removable cap (not shown) which may attach to the body around the tip, generally when the marker is not in use. The removable cap may be detached from the body or removed from the tip end to expose the tip end, when the marker 100 is in use.

With continued reference to FIGS. 2A and 2B, tip 102 is shown extending from a core 116, with a first end 118 of the tip 102, in contact with or connected to the core 116. The core 116 may also be referred to as wadding in some embodiments, and tip 102 may be, for example, in contact with the core 116 at the first end 118. In other embodiments, tip 102 may have the first end connected to the core 116. In still other embodiments, tip 102 may have, for example, the first end 118 embedded within the core 116. In still other embodiments, tip 102 may be, for example, a narrower extension of the core 116. Core 116 may be completely within the body 110. The core 116 may be, for example, cylindrical but may be of any shape configured (e.g., shaped and dimensioned) to fit within the body 110. The diameter of the core 116 may be, for example, smaller than the longitudinal length (from the tip towards the back of the body).

In some embodiments, core 116 may be removable from the body 110, such that a replacement core (not shown) configured (e.g., shaped and dimensioned) like the core 110 may be inserted into the body 110 to replace the core 116 and the replacement core connected to or put in contact with the tip 102.

The tip 102 may be configured (e.g., shaped and dimensioned) to be cylindrical or like a rectangular box from the first end 118 and towards the second end 112. As shown in FIG. 1, the tip 102 may taper towards the second end 112. However, in other embodiments, the tip 102 may have no tapering.

With continued reference to FIGS. 2A and 2B, tip 102 may be removable, such that a replacement tip (not shown) may be inserted into the body 110, with the first end 118 placed in contact with or connected to the core 116.

The core 116 may be formed from an absorbent material, with the absorbent material serving as a carrier for ink. For example, the absorbent material may be from a natural fiber or a synthetic fiber, such as cotton or a polyester fiber. In other embodiments, the core 116 may be a hollow canister or cartridge containing ink. The tip 102 may be, formed from an absorbent material, with the tip 102 depositing ink on contact with a surface. For example, the tip may be from a natural fiber or a synthetic fiber, such as cotton or a polyester fiber.

The preferred ink within marker 100 is indelible ink (more commonly known as permanent ink) such that it is not easily removed from the surface on which it is used. In other embodiments, other ink types may be used such as, for example, dry erase ink, waterproof, wet-erase, acrylic, or any commercially available ink.

The tip 102, in FIGS. 2A and 2B, depicts the first side 104 and the second side 106 having approximately the same length extending out from the narrowed end 114 of body 110. The tip 102 may be, for example, of a size commonly referred to as an extra fine tip, a fine tip, a medium tip, a broad tip, or a jumbo tip or extra broad tip. The tip 102 may be of a shape or style such as, for example, a brush tip, a chisel tip, a fine tip, or a bullet tip. However, regardless of tip size or shape or style, the tip 102 is configured (e.g., shaped and dimensioned) such that concave section 108 may accommodate a portion of the exterior circumference of an intravenous tube 300. The portion of the exterior circumference may also be referred to as a circumferential arc. Concave section 108 may be semi-circular, u-shaped, or v-shaped, extending from the second end 112 of tip 102 and towards the first end 118. The concave section 108 may be, positioned between the first side 104 and the second side 106 as shown in FIGS. 2A and 2B. However, in other embodiments, the concave section 108 may formed between a side (e.g., first side 104 or first side 106) and the second end 112. As shown in FIG. 2C, the concave section 108 is shown between the first side 104 and the second end 112.

With reference to FIGS. 1A and 1B, the body 110 may be colored to indicate the color of the ink contained in the marker 100. In other embodiments, the body may have a section colored to indicate the color of the ink contained in the marker 100. In still other embodiments, the marker 100 may have a cap (not shown) which may have a section colored or the cap may be completely colored to indicate the color of ink contained in the marker 100.

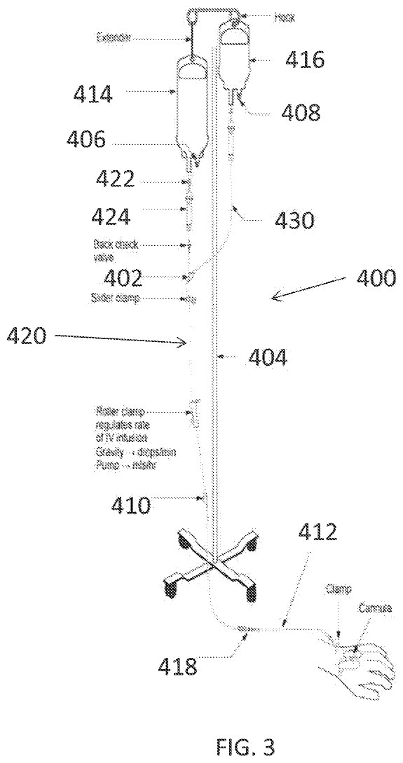

With reference to FIG. 3, a tubing setup 400 is depicted having a primary intravenous (IV) tubing 420 connected to secondary intravenous (IV) tubing 430. With reference to FIGS. 2A-2C, intravenous tube 300 may be a generic representation of IV tubing such as, for example, primary IV tubing 420 and secondary IV tubing 430 of FIG. 3. A primary IV bag 414 and a secondary IV bag 416 are depicted hanging from an IV pole 404. The primary IV tubing 420 is connected to the primary IV bag 414 by a sterile spike 422 having an opening to allow fluid to pass from the primary IV bag 414 into the primary IV tubing 420. The primary tubing 420 extends from the sterile spike 422 to a Luer Lock 418 connected to extension tubing 412 connected to a patient. The Luer Lock 418 may, for example, have male and female portion that connect to form the Luer Lock, with a male or female portion connected to the primary IV tubing 420 and a male or female portion connected to the extension tubing 412, such that the primary IV tubing 420 and the extension tubing 412 connect to form a Luer Lock 418. The extension tubing 412 may also be referred to as a patient connection. The extension tubing 412 may, for example, be intravenous tubing that includes a cannula on the end opposite the Luer Lock 418 and insertable into a patient's hand or wrist area (e.g., a vein in the hand or wrist area). The sterile spike 422 may extend from a housing or from a drip chamber 424. The primary IV tubing 420 may also have, for example, the drip chamber 424 below the sterile spike 422, a back check valve below the drip chamber 424, a slider clamp, a first port 402, a roller clamp, a second port 410, and the Luer lock 418. The first port 402 and the second port 410 may be between the sterile spike 422 and the Luer Lock 418. The Luer lock 418 may be, for example, connected to extension tubing 412 connected to a patient, as shown. The secondary IV tubing 430 may be connected to the secondary IV bag 416 through a sterile spike of the same kind as that of the primary IV tube 420. The secondary IV tubing 430 may also have a drip chamber. The secondary IV tubing 430 is shown connected to the primary IV tubing 420 at the first port 402. The primary IV bag 420 has an injection port 406 and the secondary IV bag 430 has an injection port 408.

While the tubing setup 400 shows the secondary tubing 430 extending from the secondary IV bag 416 and connected to the primary IV tubing 420 at a point between a primary IV bag 414 and the patient, in other embodiments there may be more than two IV tubes and there may be more than two IV bags. There may be IV tubing with more than two ports (e.g., the first port 402 and the second port 410). Other IV tubes may be connected to the ports located on the primary IV tube 420. The secondary tubing 430 may also have ports for connection to IV tubing.

In an emergency trauma center, or an intensive care facility, or similar environments, an intravenous tubing setup (e.g., the tubing setup 400) may include the primary IV tubing 420, the secondary IV tubing 430, tertiary IV tubing (not shown), and/or more tubing. For example, a primary tube (e.g., the primary IV tubing 420) may have three ports, with each port having an IV tube connected to it and each of the other IV tubes connected to the primary tube may have ports, into which still other tubes are connected, with each tube connected to a fluid source such as an IV bag (e.g., the primary IV bag 414 and/or the primary IV bag 416). Furthermore, while the extension tubing 412 is shown connected to the patient's hand or wrist area (e.g., a vein in the hand or wrist area) the extension may, for example, be connected to another vein of an extremity, an artery of an extremity, or an epidural space. There may also be sets of pluralities of IV tubing connected via ports to a primary IV tube (e.g., primary IV tubing 420) and to extension tubing connected to a vein of an extremity, and/or an artery of an extremity, and/or an epidural space.

With further reference to FIG. 3, the ports (e.g., port 402 and port 410) may have an IV tube connect to various other IV tubes, with each connected to an IV bag (e.g., the primary IV bag 414 or secondary IV bag 416) containing an infused solution. Since there may be a plurality of infused solutions, it is beneficial to track these solutions to the extension tubing entering the patient.

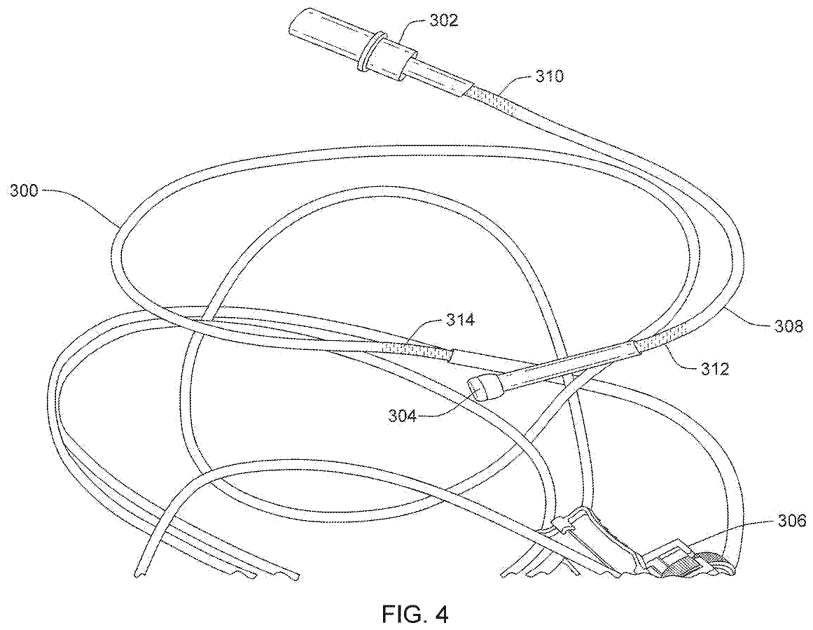

With reference to FIG. 4, the IV tubing 300 is shown with markings to identify different fluids inserted within different ports. The IV tubing 300 is shown with an injection port 304 also known as a lumen side port. The injection port 304 may be used a site for injecting a fluid into the IV tubing 300 or it may be used to connect another IV tube. The tube 308 extends from the injection port 304 to a Luer lock 302, to which additional IV tubing may be connected or which may be used to connect to tubing with a cannula leading to a patient (as shown in FIG. 3). A fluid may, for example, flow from an IV bag (e.g., of the type similar to the primary IV bag 414 of FIG. 3) and through tubing 300 and into tubing connected to the Luer lock 302 and into the patient.

The tube 300 is similar to the primary IV tubing 420 shown in FIG. 3 and the general positions of the various components on tubing 300 may be, for example, similarly configured (e.g., positioned, shaped, and dimensioned). Continuing with reference to FIG. 4, a first marking 314 is shown on tube 300 prior to connection with the injection port 304, indicating that a fluid associated with that color of marking is entering the injection port 304. A second marking 308, of the same color as the first marking 314 is shown on tube 300 to indicate that this fluid is also flowing past the injection port 304. Third marking 310 of the same color as the first marking 314 and the second marking 308 is on the tubing prior to the Luer Lock 302, indicating that the fluid entering and leaving injection port 304 is flowing through tube 300 and entering the Luer lock 302.

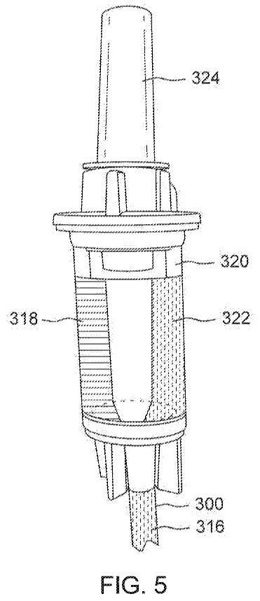

With reference to FIG. 5, a drip chamber 320 is show, with tube 300 connected at a fluid exit end of the drip chamber 320. The drip chamber 320 may be, for example, connected at an end of tube 300 and connectable via a sterile spike to an IV bag. The tube 300 and the drip chamber 320 are similar to the primary IV tubing 420 shown in FIG. 3 and the general positions of the various components on tubing 300 may be, for example, similarly configured (e.g., positioned, shaped, and dimensioned).

With continued reference to FIG. 5, a fourth marking 316 is visible on tube 300 exiting the drip chamber 320. A fifth marking 322 is on the drip chamber 320. The fifth marking 322 and the fourth marking 316 are the same color, indicating that fluid (not shown) in the drip chamber 320 and fluid exiting the drip chamber 320 is the same. With reference to FIGS. 4 and 5, the first marking 314, the second marking 308, the third marking 310, the fourth marking 316, and the fifth marking 322 are the same color, indicating that fluid associated with that color, entering the drip chamber 320 is also flowing into the tubing 300, past the injection port 304 and to the Luer lock 302.

With reference to FIGS. 4 and 5, a sixth marking 318 is on the drip chamber 320, and the sixth marking is of a different color than the first marking 314, the second marking 308, the third marking 310, the fourth marking 316, and the fifth marking 322. Sixth marking 318 indicates that another fluid is entering the drip chamber 320.

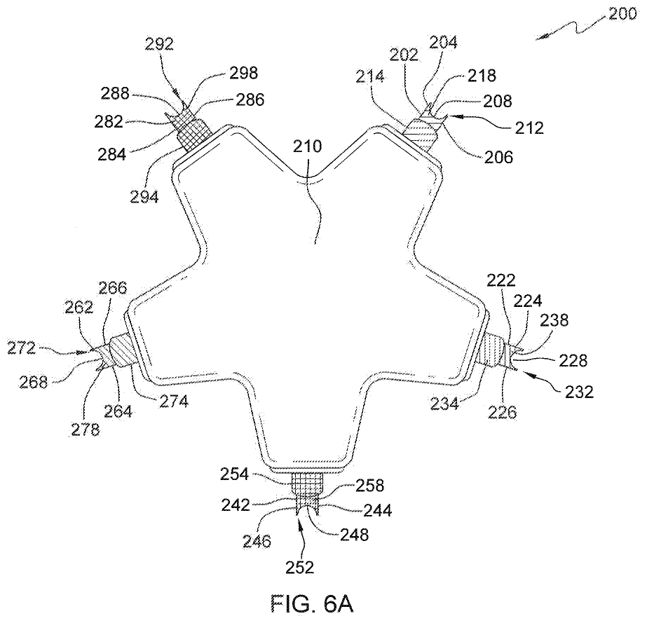

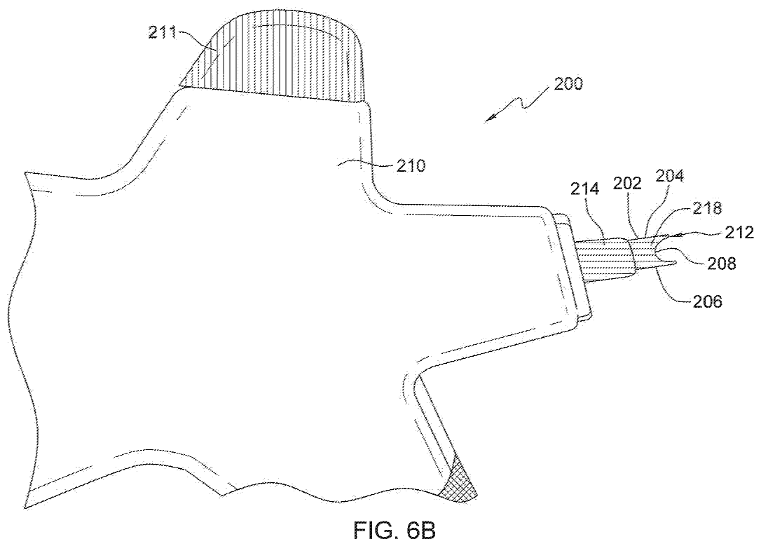

Referring to FIG. 6A, a marker 200, an embodiment of the marker 100, is shown. The marker 200 is shown having a star shaped body 210, with each end of a star corresponds to a different color tip similar to tip 102 of marker 100. A first color tip 202, a second color tip 222, a third color tip 242, a fourth color tip 262, and a fifth color tip 282 are shown extending from body 210, with each tip extending from the star shaped body 210 from where a point of the five-sided start should be. The first color tip 202 has a free end 212 extending from the body 210 from a narrower section 214. The free end 212 is between a first side 204 opposite a second side 206. The free end 212 has a concave section 208 between the first side 204 and the second side 206, with the concave section 208 shown extending or curves towards the body 210 in a semi-circular section. The concave section 208 may be, for example, a semi-circular shape, a U-shape, or a V-shape. The second color tip 222 has a free end 232 extending from the body 210 from a narrower section 234. The free end 232 is between a first side 224 opposite a second side 226. The free end 232 has a concave section 228 between the first side 224 and the second side 226, with the concave section 228 shown extending or curves towards the body 210 in a semi-circular section. The concave section 228 may be, for example, a semi-circular shape, a U-shape, or a V-shape. The third color tip 242 has a free end 252 extending from the body 210 from a narrower section 254. The free end 252 is between a first side 244 opposite a second side 246. The free end 252 has a concave section 248 between the first side 244 and the second side 246, with the concave section 248 shown extending or curves towards the body 210 in a semi-circular section. The concave section 248 may be, for example, a semi-circular shape, a U-shape, or a V-shape. The fourth color tip 262 has a free end 272 extending from the body 210 from a narrower section 274. The free end 272 is between a first side 264 opposite a second side 266. The free end 272 has a concave section 268 between the first side 264 and the second side 266, with the concave section 268 shown extending or curves towards the body 210 in a semi-circular section. The concave section 268 may be, for example, a semi-circular shape, a U-shape, or a V-shape. The fifth color tip 282 has a free end 292 extending from the body 210 from a narrower section 294. The free end 292 is between a first side 284 opposite a second side 286. The free end 292 has a concave section 288 between the first side 284 and the second side 286, with the concave section 288 shown extending or curves towards the body 210 in a semi-circular section. The concave section 288 may be, for example, a semi-circular shape, a U-shape, or a V-shape.

With reference to FIG. 6B, a close-up of tip 202 is shown. Tip 202 has a front side 218 opposite a back side (not shown), with the front side 218 tapering towards a back side (not shown) longitudinally towards the free end 212. With reference to FIGS. 6A and 6B, tip 222, tip 242, tip 262, and tip 282 are similarly configured (e.g., shaped and dimensioned). Second colored tip 222 has a front side 238 opposite a back side (not shown), with the front side 238 tapering towards a back side (not shown) longitudinally towards the free end 232. Third colored tip 242 has a front side 258 opposite a back side (not shown), with the front side 258 tapering towards a back side (not shown) longitudinally towards the free end 252. Fourth colored tip 262 has a front side 278 opposite a back side (not shown), with the front side 278 tapering towards a back side (not shown) longitudinally towards the free end 272. Fifth colored tip 282 has a front side 298 opposite a back side (not shown), with the front side 298 tapering towards a back side (not shown) longitudinally towards the free end 292.

In other embodiments, the tip 202, the tip 222, the tip 242, the tip 262, and the tip 282 may have no tapering. The tip 202, the tip 222, the tip 242, the tip 262, and the tip 282 may be of a shape or style such as, for example, a brush tip, a chisel tip, a fine tip, or a bullet tip. However, regardless of tip size or shape or style, the tip 202, the tip 222, the tip 242, the tip 262, and the tip 282 are configured (e.g., shaped and dimensioned) such that concave section (e.g. concave section 208, concave section 228, concave section 248, concave section 268, and concave section 288) may accommodate a portion of the exterior circumference of an intravenous tube 300.

With reference to FIG. 6B, a cap 211, is shown covering the second tip 222. The cap is depicted as being rounded but may be of any suitable shape to cover the second tip 222.

With reference to FIGS. 6A and 6B, the body 210 may be colored near the tip (e.g., the tip 202, tip 222, tip 242, tip 262, and tip 282) to indicate the color of the ink contained in each tip. In other embodiments, the body may have a section colored near the tip (e.g., the tip 202, tip 222, tip 242, tip 262, and tip 282) to indicate the color of the ink contained in the tip. In still other embodiments, the marker 200, each tip (e.g., the tip 202, tip 222, tip 242, tip 262, and tip 282) may have a cap such as the cap 211 which may have a section colored or the cap may be completely colored to indicate the color of ink contained in the tip.

In other embodiments, the body 110 of marker 100 or the body 210 of marker 200 may be, for example, any shape with at least one end having a marker tip (e.g., tip 102, tip 202, tip 222, tip 242, tip 262, or tip 282). Other embodiments of marker 100 may have more than one tip with, for example, a second tip at end 105 of FIG. 1A.

With reference to FIGS. 1-5, a system for tracking fluid in intravenous tubes is shown with at least one intravenous tube (e.g., IV tube 300, primary IV tubing 420, and secondary IV tubing 430) having a first end, at least one port (e.g., first port 402 and/or second port 410), and a second end. The first end may be, for example, a drip chamber 320, or a sterile spike 324 and spike housing. The second end may be, for example a Luer Lock (e.g. Luer Lock 418 or Luer Lock 302). Upon connecting the first end to a fluid source (e.g., primary IV bag 414 or secondary IV bag 416), the concave section 108 of marker 100 may be placed on the exterior circumferential arc of the at least one intravenous tube (e.g., IV tube 300, IV tube 420, or IV tube 430) near the first end dispensing indelible ink and forming a first mark near the first end. Upon connecting the second end of the intravenous tube to a patient connection (e.g., extension tubing 412 or a cannula), the concave section 108 of marker 100 may be placed on the circumferential arc of the at least one intravenous tube near the second end dispensing indelible ink and forming a second mark near the second end. This first mark and the second mark may be of the same color. The first mark and the second mark may then be associated with the source of fluid carried by the at least one intravenous tube to the patient.

For each fluid added to the system, whether through the IV bag (e.g., primary IV bag 414 or secondary IV bag 416), an injection port (e.g., injection port 406), or another port (e.g., port 402 and/or port 410), a color of indelible ink may be associated with the introduced fluid, such that the colors may be different for each fluid. A first mark of the color associated with the fluid may be added to the tube (e.g., IV tube 300, primary IV tubing 420, and secondary IV tubing 430) near the source of the fluid and a second mark of the same color as the first mark may be made near the second end, such that each color of indelible ink used is associated with a different fluid. Each first mark and second mark pair may be the same and associated with a fluid, with each first mark and second mark pair being a different color from each other pair.

With continued reference to FIGS. 1-5, the placement of each different colored mark on the tubing (e.g., IV tube 300, primary IV tubing 420, and secondary IV tubing 430), may be, for example, placed adjacent or near to each subsequent mark, but not on top of each other so as to obscure the colors.

The association of marker colors with a fluid may include, marking a chart and writing the fluid name next to the mark. In another embodiment, the association of marker colors may involve a computer generated color mark similar to the marker mark and the entry of a fluid name next to the mark. Other methods of recording a fluid with an associated color may also be used.

While a fluid source is depicted in FIG. 3 as a primary IV bag 414 or a secondary IV bag 416, other fluid sources may include an injection into an injection port (e.g., the injection port 406 or injection port 408), or an injection into a port (e.g., port 402 or port 410), or an attachment of a subsequent IV bag connected to the port (e.g., port 402 or port 410), or any fluid introduced into IV tubing (e.g., primary tubing 420 or secondary tubing 430) from any source using the tubing to deliver fluid to a patient.

With reference to FIGS. 3-6B, the marker 200 has a plurality of tips (e.g., the first color tip 202, the second color tip 222, the third color tip 242, the fourth color tip 262, and the fifth color tip 282). Each of the plurality of tips is shown extending from the marker 200 towards a free end (e.g., the free end 212, the free end 232, the free end 252, the free end 272, and the free end 292), and each free end has a concave section (e.g., concave section 208, concave section 228, concave section 248, concave section 268, and concave section 288) between a first side (e.g., first side 204, first side 224, first side 244, first side 264, and first side 284) and a second side (e.g., second side 206, second side 226, second side 246, second side 266, and second side 286) with the concave section configured (e.g., sized and dimensioned) to accommodate a circumferential arc of the intravenous tube (e.g., IV tube 300, IV tube 420, and IV tube 430). Each of the plurality of tips provides indelible ink of a different color different. Each color is associated with a different fluid, and a first mark of one color may be made on the intravenous tube near the injection site and a second mark of the same color as the first mark, may be made. Each first mark and second mark pair may be the same and associated with a fluid, with each first mark and second mark pair being a different color from each other pair.

While a first mark, near an injection site, and a second mark, near the patient connection, of matching colors and associated with a fluid are described, in certain embodiments there may be more than two marks. For example, with reference to FIG. 3, the injection of fluid into the injection port 408 of the secondary IV bag 416 may include adding a first mark near the injection site (e.g., a drip chamber, or the secondary tubing 430 near the drip chamber, or the secondary IV bag), a second mark near the Luer Lock 418, and a third mark near port 402. Using multiple markings may provide easier tracking of the fluid entry point.

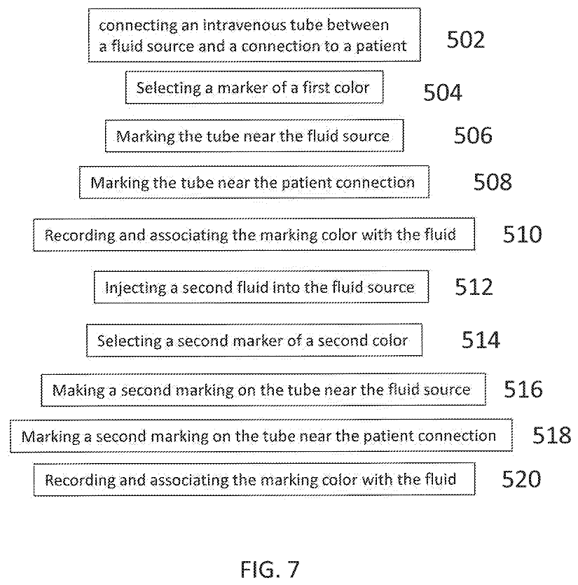

With reference to FIG. 7, a block diagram depicting a method for tracking fluids in intravenous tubing is shown. In describing the method, references to objects marked in FIGS. 1-5 may be made. An intravenous tube may be connected to a fluid source at one end and a patient at a second end 502. A marker having indelible ink of a first color may be selected 504. The marker may have a concave section at an end of a tip with the concave section configured (e.g., sized and dimensioned) to accommodate a circumferential arc of the intravenous tube as in FIGS. 1-2C, 6A and 6B. The concave section may be placed in contact with the circumferential arc of the IV tube near the first end of the tube. The IV tube may be marked with the first color near the fluid source, applying indelible ink of the first color on the circumferential arc of the intravenous tube 506. The concave section of the marker tip may be placed near the second end of the IV tube and the IV tube may be marked with indelible ink of the first color 508. The first color may be associated with a fluid from the intravenous fluid source and recorded 510.

With continued reference to FIG. 7, a second fluid may be injected into the fluid source 512. A second marker having indelible ink of a second color may be selected 514. The second marker may have a concave section at an end of a tip with the concave section configured (e.g., sized and dimensioned) to accommodate a circumferential arc of the intravenous tube as in FIGS. 1-2C, 6A and 6B. The concave section may be placed in contact with the circumferential arc of the IV tube near the first end of the tube. The IV tube may be marked with the second color near the fluid source, applying indelible ink of the second color on the circumferential arc of the intravenous tube 516. The concave section of the second marker tip may be placed near the second end of the IV tube and the IV tube may be marked with indelible ink of the second color 518. The second color may be associated with the injected fluid and recorded 510.

The method depicted in FIG. 7 refers to the first fluid in the fluid source and the second fluid injected into the fluid source. There may be multiple fluid sources connected by the IV tubing to the patient, with each fluid in the fluid source being associated with a different color. There may be multiple injections into a fluid source or into fluid sources, connected by the IV tubing to the patient, with each fluid in the fluid source or fluid sources being associated with a different color.

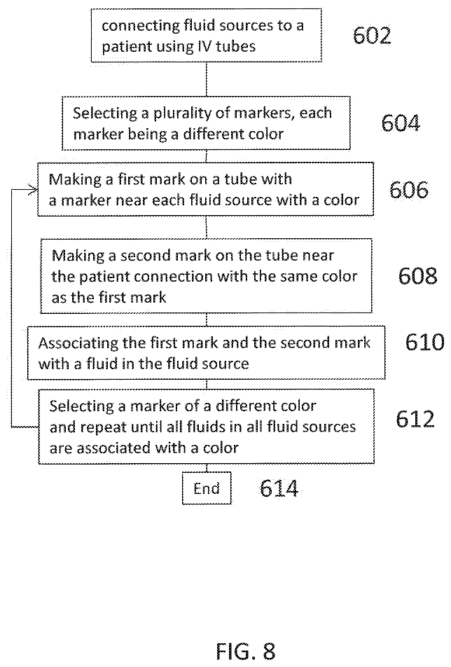

With reference to FIG. 8, a workflow diagram depicted a method for tracking fluids administered to a patient from a plurality of IV fluid sources, a plurality of fluids, and a plurality of IV tubes. In describing the method, references to objects marked in FIGS. 1-5 may be made. The plurality of fluid sources may be connected to the patient using IV tubes 602. A plurality of markers may be selected with each of the plurality of markers having ink of a different color 604. Each of the plurality of markers may have a concave section at an end of a tip, the concave section sized and dimensioned to accommodate a circumferential arc of each of the plurality of intravenous tubes. Selecting a marker from the plurality of markers and making a first mark on the IV tube near the IV fluid source 606. The mark may be made by placing the concave tip in contact with the circumferential arc of the intravenous tube at the first end of the intravenous tube. Making a second mark on the tube near a patient connection where the first mark and the second mark are the same color 608. The color of the first mark and the second mark may be associated with a fluid in the fluid source 610. Subsequent markers of a different ink color may be selected and the previous marking and association steps may be repeated until each fluid in all fluid sources is associated with a different color 612. After each fluid is associated with a different color, the workflow is complete and each fluid is identifiable by color 614.

With reference to FIGS. 1-8, medical professionals may be able to track a fluid, the fluid source, and an entry into an appropriate patient connection for that fluid by referring to a color marked on the tube. This also removes the need to follow the tube from the patient connection back to the fluid source. Providing markers configured for marking IV tubing may, for example, minimize mistakes due to incorrectly identifying fluid entering a patient and save time in a high stress environment.

In certain other embodiments, a case or container may be provided for housing and/or carrying a plurality of markers (e.g., the marker 100 and/or the marker 200) with the color of the indelible ink for each of the plurality of markers being different and/or distinct. There may be a kit having a case configured to store and display a plurality of markers, and configured (e.g., shaped and dimensioned) to make visible the different colors of the markers within the container.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A marker comprising;
a body;
a core having an ink and the core being within the body;
a tip having a first end connected to the core and the tip extending from the body towards a second end; the tip further having a first side opposite a second side and a front side opposite a back side, with the first side and second side therebetween;
the second end having a concave section between the first side and the second side; and
the concave section configured to accommodate a circumferential arc of intravenous tubing within the concave section to deposit the ink.

2. The marker of claim 1 wherein the core has indelible ink.

3. The marker of claim 1 further comprising:
a second core having an ink and the second core being within the body;
a second tip having a first end within the body and extending from the body towards a second end, the second tip further having a first side opposite a second side and a front side opposite a back side, with the first side and second side therebetween,
the first end of the second tip connected to the second core within the body;
the second end of the second tip having a concave section between the first side and the second side; and
the second tip sized and dimensioned to accommodate the circumferential arc of intravenous tubing within the concave section and deposit the ink.

4. The marker of claim 3 wherein the second core has indelible ink.

5. The marker of claim 1 further comprising:
a plurality of cores each having an ink and the plurality of cores being within the body;
a plurality of tips each having a first end within the body and extending from the body towards a second end, the plurality of tips each further having a first side opposite a second side and a front side opposite a back side, with the first side and second side therebetween;
the first end of each of the plurality of tips being connected to one of the plurality cores within the body;
the second end of each of the plurality of tips having a concave section between the first side and the second side; and
each of the plurality of tips configured to accommodate the circumferential arc of intravenous tubing within the concave section and deposit the ink.

6. The marker of claim 5 wherein each of the plurality of cores has indelible ink.

7. The marker of claim 1, wherein the tip is a brush tip, a chisel tip, a fine tip, or a bullet tip.

8. The marker of claim 1, wherein the concave section is a semi-circle, a U-shape, or a V-shape.

9. The marker of claim 1, wherein the body has at least a section colored to match the color of the ink.

10. A method for tracking fluids in intravenous tubing comprising:
connecting an intravenous tube at a first end to a fluid source and at a second end to a patient connection;
selecting a marker having indelible ink of a color, the marker having a concave section at an end of a tip, the concave section sized and dimensioned to accommodate a circumferential arc of an intravenous tube;
placing the concave section in contact with the circumferential arc of the intravenous tube near the first end of the intravenous tube;
marking near the first end of the intravenous tube with the concave marker and applying indelible ink of the color on the circumferential arc of the intravenous tube;
placing the concave section in contact with the circumferential arc of the intravenous tube near the second end of the intravenous tube;
marking near the second end of the intravenous tube with the marker such that indelible ink of the color remains on the circumferential arc of the intravenous tube; and
recording and associating the color with a first intravenous fluid.

11. The method of claim 10, further comprising:
injecting a second fluid into the fluid source;
selecting a second marker having indelible ink of a second color, the second marker having a concave section at an end of a tip, the concave section sized and dimensioned to accommodate a circumferential arc of the intravenous tube;
placing the concave section of the second marker in contact with the circumferential arc of the intravenous tube near the first end of the intravenous tube;
marking near the first end of the intravenous tube with the second marker and applying indelible ink of the second color on the circumferential arc of the intravenous tube;
placing the concave section in contact with the circumferential arc of the intravenous tube near the second end of the intravenous tube;
marking near the second end of the intravenous tube with the second marker such that indelible ink of the second color remains on the circumferential arc of the intravenous tube; and
recording and associating the second color with a first intravenous fluid.

12. A method for tracking fluids in intravenous tubing comprising:
a) selecting a plurality of intravenous tubes each connected at a first end to at least one fluid source and at a second end to a patient connection;
b) selecting a plurality of markers, each of the plurality of markers having indelible ink of a different color, and each of the plurality of markers having a concave section at an end of a tip, the concave section sized and dimensioned to accommodate a circumferential arc of each of the plurality of intravenous tubes;
c) selecting a marker of the plurality of markers and selecting an intravenous tube of the plurality of intravenous tubes and placing the concave tip in contact with the circumferential arc of the intravenous tube at the first end of the intravenous tube;
d) marking near the first end of the intravenous tube with the concave tip and applying indelible ink of a color on the circumferential arc of the intravenous tube;
e) placing the concave tip in contact with the circumferential arc of the intravenous tube near the second end of the intravenous tube;
f) marking the second end of the intravenous tube with the concave tip such that indelible ink of the color remains on the circumferential arc of the intravenous tube and the marking near the first end and the marking near the second end are of the same color;
g) recording and associating the color with the source of the intravenous fluid; and
h) repeating steps c)-g) for each of the plurality of intravenous tubes until each of the plurality of intravenous tubes is marked with a different color.

13. The method of claim 12 further comprising:
a) selecting from the plurality of intravenous tubes, a tube having an injection port;
b) selecting from the plurality of markers, a marker having indelible ink of a different color;
c) selecting the tube with the injection port;
d) injecting fluid into the injection port;
e) marking a section of the tube near the injection port with the concave tip of the marker;
f) marking near the second end of the intravenous tube with the concave tip of the marker, such that the color near the injection port and the color near the second end are the same;
g) recording and associating the color, with the fluid injected into the injection port.

14. The method of claim 12 further comprising:
a) selecting an injection port from a fluid source;
b) selecting from the plurality of markers, a marker having indelible ink of a different color;
c) selecting the tube leading from the fluid source;
d) injecting fluid into the injection port;
e) marking a section of the tube leading from the fluid source with the concave tip of the marker;
f) marking near the second end of the intravenous tube with the concave tip of the marker, such that the color near the injection port and the color near the second end are the same;
g) recording and associating the color, with the fluid injected into the injection port.

15. The method of claim 12 further comprising:
a) selecting from the plurality of intravenous tubes, a tube having an injection port;
b) connecting a first end of a second tube to the injection port, the second tube connected at a second end to a fluid source;
c) selecting from the plurality of markers, a marker having indelible ink of a different color;
d) selecting the second tube;
e) marking the second tube near the second end with the concave tip of the marker;
f) marking the second tube near the first end with the concave tip of the marker, such that the color near the first end and the color near the second end are the same;
g) marking the tube, selected from the plurality of intravenous tubes, near the injection port, such that the marking color is the same as the marking color on the second tube
h) recording and associating the color, with the fluid in the second tube and connected to the injection port.
